(19) United States
(12) Patent Application Publication
(10) Pub. No.: US 2019/0283075 A1
(43) Pub. Date: Sep. 19, 2019

(54) Rotary Applicator Devices for Applying a Material to a Surface

(71) Applicant: Solisto Auto Glass LLC, St. George, UT (US)

(72) Inventor: Jeffrey Duston Lambert, St. George, UT (US)

(21) Appl. No.: 15/921,612

(22) Filed: Mar. 14, 2018

(51) Int. Cl. B05C 17/02

(52) U.S. Cl. CPC B05C 17/0207; B05C 17/022; B05C 17/0205

(57) ABSTRACT

A rotary applicator device comprises a handle member having a longitudinal axis, and an elongate member rotatably interfaced with the handle member. The elongate member comprises an applicator attachment portion. An applicator is removably coupled to the applicator attachment portion and is comprised of an absorbent material configured to absorb a material, such as paint, stain, or adhesive. The elongate member and the applicator are operable to rotate about the longitudinal axis while the handle member is moved in a direction transverse to the longitudinal axis, thereby facilitating deposit of a portion of the material from the applicator onto a surface while the applicator rotates along the surface.

### GOVERNMENT LICENSE RIGHTS

None.

### BACKGROUND

Many types of material applicators are available on the market, such as paint rollers, adhesive applicators, stain applicators, and other applicators that apply a fluidic material onto a surface. These devices typically have a handle/pole and a roller frame rotatably coupled to each other, such as a paint roller set up. The user can slidably engage a disposable applicator/pad to the roller frame, and then the applicator/pad can be rolled along a wall or surface via the handle to apply the paint (or stain) from the applicator/pad to the wall surface. Typically, the axis of rotation of the roller frame (and the attached applicator/pad) is orthogonal to a longitudinal axis of the handle/pole, such as with a typical paint pole/roller combination for painting a wall. However, in tight areas such as when painting handrails, or when painting near wall corners, it can be difficult or impossible to apply the paint to certain surfaces without the handle impacting another surface, because of the arrangement of the applicator having a rotational axis different from (i.e., orthogonal) the longitudinal axis of the handle. Moreover, because such existing handles and frames are fixed to each other, the user is limited regarding the different surface areas the user can access with the frame to apply the material with the applicator.

Other devices, such as small daubers, include a handle supporting a fixed applicator for applying a material to a surface for, such for applying an adhesive to a glass, a stain to leather, etc. These take the shape of a small handheld pencil-like device. Applying material to small surfaces and areas can require precise control over the dauber to apply the material. However, such fixed daubers do not have a pad that rolls because the pads are fixed to the handle, so the user must rotate the handle/frame in the hand in order to apply the material from the dauber to the surface, which is inefficient and time consuming.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates an elongate member of a rotary applicator device in accordance with an example of the present disclosure;

FIG. 2 illustrates a rotary applicator device having the elongate member of FIG. 1 interfaced with a handle member, without an applicator, in accordance with an example of the present disclosure;

FIG. 3 illustrates a rotary applicator device, without an applicator, in accordance with an example of the present disclosure;

FIG. 4 illustrates a variety of applicators usable with a rotary applicator device, such as in FIGS. 2 and/or 3, in accordance with an example of the present disclosure;

FIG. 5 illustrates a rotary applicator device in accordance with an example of the present disclosure;

FIG. 6 illustrates a rotary applicator device in accordance with an example of the present disclosure;

FIG. 7 illustrates a partially exploded view of a rotary applicator device in accordance with an example of the present disclosure;

FIG. 8 illustrates an applicator attachment device of a rotary applicator device in accordance with an example of the present disclosure;

FIG. 9 illustrates an applicator attachment device of a rotary applicator device in accordance with an example of the present disclosure;

FIG. 10 illustrates a rotary applicator device in accordance with an example of the present disclosure;

FIG. 11 illustrates the applicator attachment device, supporting an applicator, of the rotary applicator device of FIG. 10 in accordance with an example of the present disclosure;

FIG. 12 illustrates a rotary applicator device in accordance with an example of the present disclosure;

FIG. 13 illustrates an exploded view of a portion of a bearing assembly of the rotary applicator device of FIG. 12, and an applicator attachment portion, in accordance with an example of the present disclosure; and

FIG. 14 illustrates the assembled components of FIG. 13 in accordance with an example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

In one example, a rotary applicator device comprises: a handle member having a longitudinal axis; an elongate member rotatably interfaced with the handle member, and the elongate member comprising an applicator attachment portion; and an applicator removably coupled to the applicator attachment portion and comprised of an absorbent material configured to absorb a material. The elongate member and the applicator are operable to rotate about the longitudinal axis while the handle member is moved in a direction transverse to the longitudinal axis, thereby facilitating deposit of a portion of the material from the applicator onto a surface while the applicator rotates along the surface.

In one example, the handle member comprises a channel that extends through the handle member and along the longitudinal axis, and the elongate member comprises a shaft that extends through the channel and rotatably supported by the handle member.

In one example, the elongate member comprises a retention member on an end opposite the applicator attachment portion. The retention member can be situated outside of the channel such that the retention member retains the shaft about the channel of the handle member.

In one example, the applicator comprises a dauber configured to absorb and apply a stain material.

In one example, the applicator attachment portion is configured to attach different types of applicators.

In one example, the applicator attachment portion is pivotally coupled to a distal end of the shaft, such that the applicator is operable to rotate along an axis of rotation at varying angles relative to the longitudinal axis of the handle member.

In one example, the handle member comprises a support end portion having an opening. The longitudinal axis extends through the opening, and the the shaft is rotatably interfaced to the opening and situated along the longitudinal axis. The rotary applicator device further comprises at least one bearing coupled to the shaft and rotatably interfacing the elongate member to the support end portion.

In one example, the at least one bearing comprises a plurality of cylindrical ball bearing devices. The shaft is coupled to central apertures of each cylindrical ball bearing device.

In one example, the handle member comprises a first handle portion and a second handle portion pivotally coupled to each other by a pivoting lock mechanism. The second handle portion supports the applicator attachment portion such that the applicator attachment portion and the applicator rotate off-axis relative to the longitudinal axis extending through the first handle portion.

In one example, the applicator comprises an axis of rotation being substantially collinear with the longitudinal axis of the handle member.

In one example, a rotary applicator device comprises: a handle member comprising a channel that extends through the handle member, and the handle member defines a longitudinal axis; an elongate member comprising an shaft that extends through the channel, and the shaft is rotatably supported by the handle member, and the elongate member comprising an applicator attachment portion; and an applicator removably coupled to the applicator attachment portion and comprised of an absorbent material configured to absorb a material. The elongate member and the applicator are operable to rotate about the longitudinal axis while the handle member is moved in a direction transverse to the longitudinal axis, thereby facilitating deposit of a portion of the material from the applicator onto a surface while the applicator rotates along the surface.

In one example, the elongate member comprises a retention member on an end opposite the applicator attachment portion. The retention member is situated outside of the channel such that the retention member retains the shaft about the channel of the handle member.

In one example, the applicator comprises an axis of rotation being substantially collinear with the longitudinal axis of the handle member.

In one example, the shaft comprises an axis of rotation being substantially collinear with the longitudinal axis of the handle member.

In one example, the applicator attachment portion is pivotally coupled to a distal end of the shaft, such that the applicator is operable to rotate along an axis of rotation at varying angles relative to the longitudinal axis of the handle member.

In one example, a rotary applicator device comprises: a handle member comprising a support end portion having an opening, the handle member defining a longitudinal axis extending through the opening; and an applicator bearing assembly comprising: an elongate member comprising a shaft rotatably interfaced to the opening of the support end portion (the shaft being situated along the longitudinal axis); at least one bearing coupled to the shaft and rotatably interfacing the elongate member to the support end portion of the handle member; an applicator attachment portion coupled to a distal end of the shaft; and an applicator removably coupled to the applicator attachment portion, and comprised of an absorbent material configured to absorb a material. The elongate member and the applicator are operable to rotate about the longitudinal axis while the handle member is moved in a direction transverse to the longitudinal axis, thereby facilitating deposit of a portion of the material from the applicator onto a surface while the applicator rotates along the surface.

In one example, the at least one bearing comprises a plurality of cylindrical ball bearing devices, the shaft coupled to central apertures of each cylindrical ball bearing device.

In one example, the handle member comprises a first handle portion and a second handle portion pivotally coupled to each other by a pivot lock mechanism. The second handle portion supports the applicator attachment portion such that the applicator attachment portion and the applicator rotate off-axis relative to the longitudinal axis extending through the first handle portion.

In one example, the rotary applicator device comprises a release mechanism supported by an end of the shaft, and the release mechanism is operable to facilitate removal the applicator attachment portion from the shaft.

In one example, the release mechanism facilitates interchanging different types of applicators to the shaft.

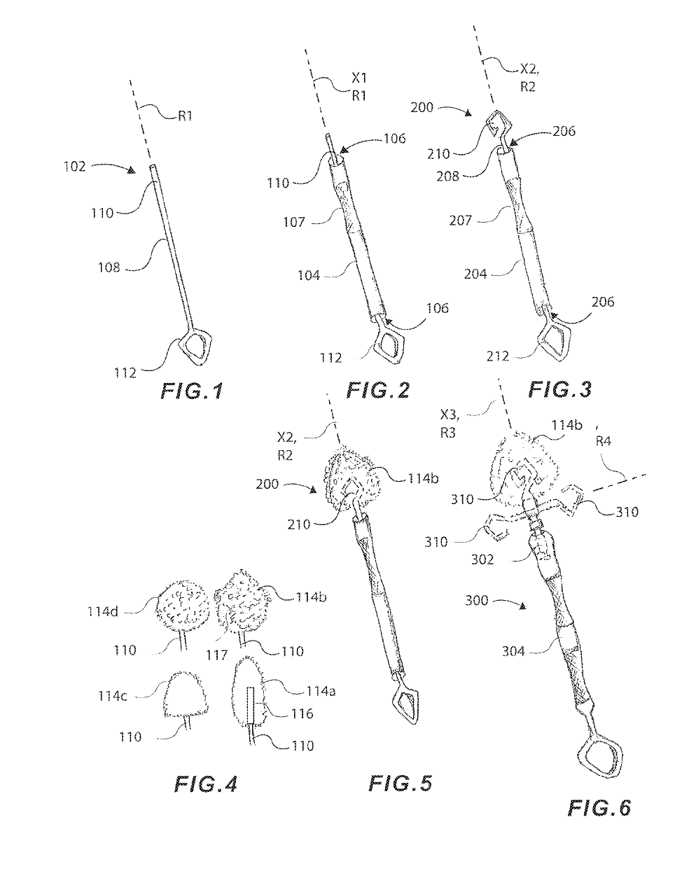

FIG. 1 shows an elongate member 102 of a rotary applicator device 100 of FIG. 2, in accordance with one example of the present disclosure. The rotary applicator device 100 can comprise a handle member 104 comprising a channel 106 that extends through the handle member 104. The handle member 104 can be an elongated tube or casing, which can have a recessed interface portion 107 for grasping the handle member 104 with a hand. The handle member 104 comprises or defines a longitudinal axis X1 that extends centrally through the channel 106 and the handle member 104. The channel 106 can be defined by a hollow channel that extends between upper and lower openings of the handle member 104. The elongate member 102 can comprise a shaft 108 that extends through the channel 106 of the handle member 104, as shown in FIG. 2. The shaft 108 can have a diameter that is slightly smaller than an inner diameter of the channel 106, so that the shaft 108 can be rotatably supported by and interfaced within the handle member 104. The handle member 104, and the elongate member 102, can be comprised of any suitable rigid material, such as a metal, wood, plastic, polymer, composite, etc.

In one example, the elongate member 102 can comprise an applicator attachment portion 110 on one end, and a retention member 112 on the other end. The retention member 112 is formed or situated outside of the channel 106 such that the retention member 112 retains the shaft 108 about the channel 106 of the handle member 104. The retention member 112 can be formed as any outward transition portion from the shaft 108 that is capable of preventing the elongate member 102 from falling out of the handle member 104 in one direction.

The applicator attachment portion 110 can be a straight shaft portion that is a further extension of the shaft 108 and that extend out of the upper opening of the handle member 104, as shown in FIGS. 1 and 2. As illustrated in FIG. 4, one of a selection of applicators 114a-d can be removably coupled or attached to the applicator attachment portion 110. In one example, each applicator 114a-d can comprise of a female receiving portion 116 (only shown with applicator 114a) that can be rotatably interfaced with the applicator attachment portion 110. The female receiving portion 116 can be a plastic housing that is cylindrically shaped as a cap, and that has a lower opening that receives the tip or end of the applicator attachment portion 110, in a manner so that the applicator is rotatably supported and coupled to the applicator attachment portion 110.

The applicators 114a-d can each comprise an absorbent material 117 (only labeled with applicator 114b), such as a collection of natural fibers, polyester, etc. that is configured to absorb a material for application onto a surface with the applicator, such as a paint or stain or adhesive that is absorbed by the absorbent material for rolling onto a surface such as a wall, rail, glass, or other surface. The absorbent material 116 can be attached (e.g., glued) to an outer surface area of the female receiving portion 116. The applicators 114a-d can have a variety or shapes and sized, such as shown in FIG. 4 (i.e., round, conical, swab shaped, irregular shaped, cylindrically shaped).

FIGS. 3 and 5 shown another example of a rotary applicator device 200, similarly configured as the rotary applicator device 100, and having an elongate member 202 rotatably interfaced or coupled to a handle member 204. The elongate member 202 can include a shaft 208 and a retention member 212 similarly formed and shaped as in the example of FIG. 2. Opposite the retention member 212, an applicator attachment portion 210 is formed having a hook or transition portion that directly receives a removable absorbent material, such as the absorbent materials shown in FIG. 4. For instance, an absorbent material can be placed over the hook, and retained in place by the hook tip and the shape of the hook.

In operation, and in one example with reference to FIG. 2 (and similarly as applicable with FIG. 3), assume that a user has removably attached applicator 114a to the applicator attachment portion 110 in the manner described above. Thus user then grasps or holds the handle member 104 with one hand, dips the applicator 114a into a viscous material (e.g., paint, stain, adhesive), and then interfaces the applicator 114a against a surface, such as near a corner of a wall to be painted, or along a surface of glass to be adhered to a structure. Then, the user can move the handle member 104 along or proximate the surface, thereby causing rotation of the applicator 114a along the surface and about an axis of rotation R1 to deposit a portion of the material from the applicator 114a onto the surface. Notably, the axis of rotation R1 of the applicator 114a is substantially collinear with the longitudinal axis X1 of the handle member 104, because of the rotatable interface configuration of the applicator 114a and the elongate member 102, as detailed above. Thus, while the handle member 104 is moved in a direction (i.e., by the user along or about the surface) transverse to the longitudinal axis X1, the elongate member 102 and the applicator 110 collectively and congruently rotate about the axis of rotation R1 and about the longitudinal axis X1. Thus, in one example of a dauber, the handle member 104 can be held like a pencil, and angled away from the surface, as it is moved along and proximate the surface while the applicator contacts the surface for application of the material, such as a stain or adhesive.

Similarly, regarding the rotary applicator device 200 of FIGS. 3 and 5, while the handle member 204 is moved in a direction (i.e., by the user along or about the surface) transverse to the longitudinal axis X2, the elongate member 202 and the applicator 210 are operable to rotate about the respective axis of rotation R2 and about the longitudinal axis X2. As can be appreciated from the similar examples of FIGS. 2 and 3, the axis of rotation R2 is substantially collinear with the longitudinal axis X2 of the handle member 204.

FIG. 6 illustrates an example of a rotary applicator device 300 that is similar to the rotary applicator device 200 of FIG. 5. Thus, the rotary applicator device 300 can include an elongate member 302 rotatably interfaced or coupled to a handle member 304. The elongate member 302 can be a shorter shaft than in FIG. 1, and can be rotatably interfaced or coupled into a bore or opening of the handle member 304. An applicator attachment portion 310 is formed having a hook that directly receives or supports a removable absorbent material, such as absorbent material 117 of FIG. 4. The applicator attachment portion 310 can be pivotally coupled to the elongate member 302 via a pivotable mechanism that facilitates rotating or pivoting the applicator attachment portion 310 to a variety of different positions, such as shown by the shadow lines of 310 illustrating two positions at 90 degrees relative to normal/vertical. The applicator attachment portion 310 can also be rotatably coupled to the elongate member 302 by a bearing or rotatable housing that rotates the applicator attachment portion 310 relative to the elongate member 302. Thus, the applicator attachment portion 310 can rotate about an axis of rotation R3 that is collinear with a longitudinal axis X3 of the handle member 304 when in the normal/vertical position as shown. The user can then selectively move or pivot the applicator attachment portion 310 relative to the handle member 304, so that applicator attachment portion 310 can then rotate about an axis of rotation R4 that is transverse to the longitudinal axis X3 of the handle member 304 (e.g., orthogonal, or any other angle desired by the user). Once pivoted to a desired position, the applicator attachment portion 310 can be locked in place by a locking device, and then the user can move the handle member 304 while the applicator 114b rotates along a surface for application of a material from the applicator 114b.

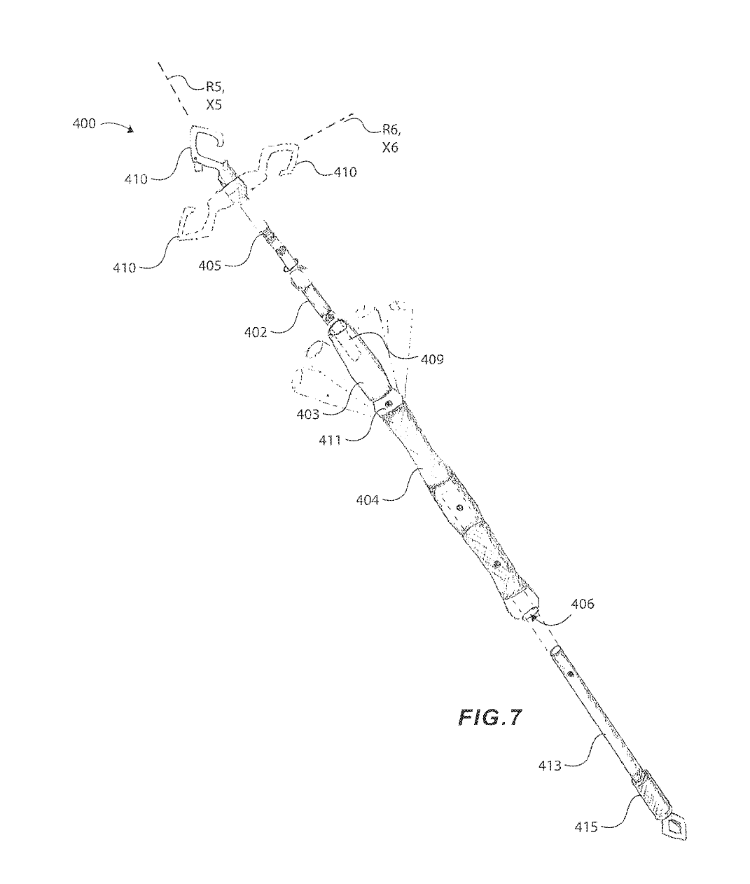

FIG. 7 illustrates an example of a rotary applicator device 400 that is similar to the rotary applicator device 300 of FIG. 6. Thus, the rotary applicator device 400 can include an elongate member 402 rotatably interfaced or coupled to a pivotable applicator support housing 403 pivotally coupled to a handle member 404. The elongate member 402 can be a shorter shaft than the shaft in FIG. 1, and can be rotatably interfaced or coupled into a bore or opening 409 of the pivotable applicator support housing 403. An applicator attachment portion 410 is formed having a hook that directly receives or supports a removable absorbent material, such as absorbent 117 of FIG. 4. The applicator attachment portion 410 can be pivotally coupled to the elongate member 402 via a pivotable mechanism, such in FIG. 6 that facilitates rotating or pivoting the applicator attachment portion 410 to a variety of different positions, as shown by the shadow lines of 410 showing two different positions relative to normal/vertical.

The applicator attachment portion 410 can also be rotatably coupled to the elongate member 402 by a bearing or housing that rotates the applicator attachment portion 410 relative to the elongate member 402. Thus, the applicator attachment portion 410 can rotate about an axis of rotation R5 that is substantially collinear with a longitudinal axis X5 of the handle member 404, and also a longitudinal axis of the pivotable applicator support housing 403. The user can selectively move or pivot the applicator attachment portion 410 relative to the handle member 404, so that applicator attachment portion 410 can then rotate about an axis of rotation R6 that is transverse to the longitudinal axis X6 of the handle member 404 (e.g., transverse such as being orthogonal, or any other possible angle desired by the user). Once pivoted to a desired position, the applicator attachment portion 410 can be locked in place by a locking device, and then the user can move the handle member 404 while the applicator (e.g., 114b) rotates along a surface for application of a material from the applicator.

In addition to such functionality, the user can also pivot the pivotable applicator support housing 403, thereby moving the pivotable applicator support housing 403 and the attached applicator attachment portion 410 relative to the handle member 404 (as shown by the shadow lines of the pivotable applicator support housing 403). In one example, a pivot locking device 411 can couple the pivotable applicator support housing 403 to the handle member 404, so that the user can effectuate movement of the applicator attachment portion 410 to a desired position. Thus, the pivotable applicator support housing 403 can have variable positions such that the elongate member 402 can rotate collinear with a selected longitudinal axis of the pivotable applicator support housing 403, and also while the applicator attachment portion 410 can rotate about a different axis than the axis of rotation of the elongate member 402, as described above.

In one example, a handle shaft member 413 can be rotatably coupled to the handle member 404 through a lower opening 406 on an end of the handle member 404. The handle shaft member 413 can have a lower handle portion 415 that a user can grasp while applying a material with an applicator on the applicator attachment portion 410, so that the user can rotate the entire handle member 404 relative to the handle shaft member 413 to manipulate the orientation of the applicator while applying a material to a surface.

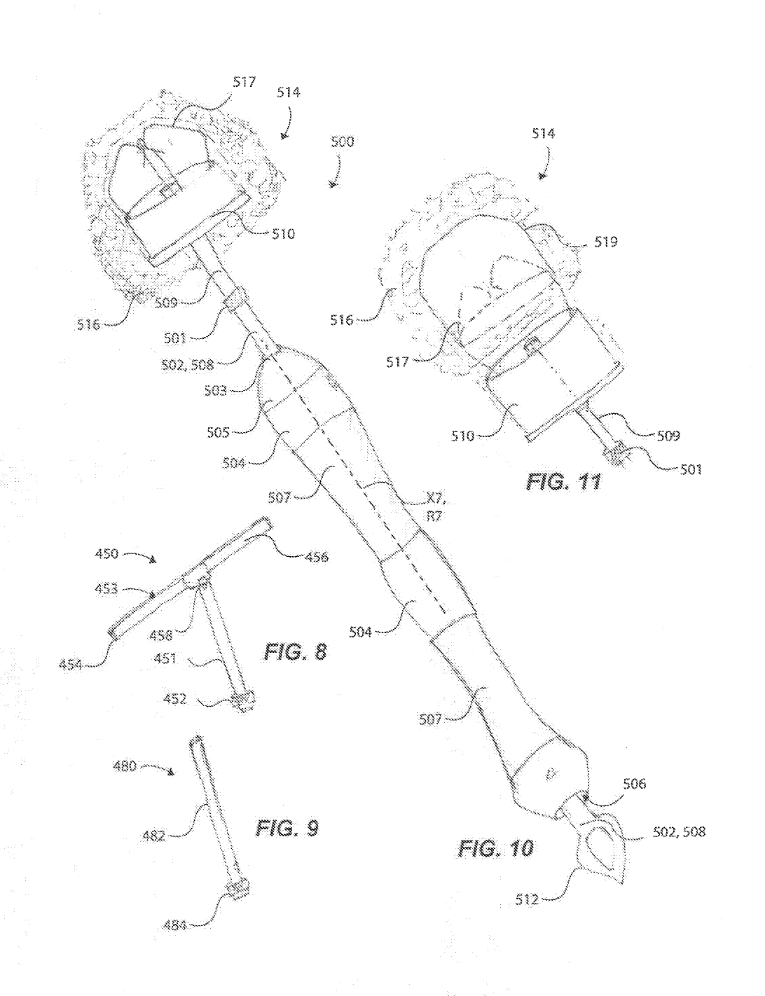

The applicator attachment portion 410 can be removably coupled to the elongate member 402 via a release mechanism, such as by unthreading one end of the applicator attachment portion 410 from one end of the elongate member 402. Thus, another type of applicator attachment portion can be attached to the elongate member as desired. For instance, FIGS. 8 and 9 show a couple of such examples of applicator attachment portions 450 and 480. The applicator attachment portion 450 of FIG. 8 includes a primary shaft 451 having a coupling portion 452 for removably coupling the applicator attachment portion 450 to the elongate member 402 of FIG. 7. The coupling portion 452 can also comprise a roller or bearing assembly that rotatably couples the applicator attachment portion 450 to a handle member or other handle device. At the other end of the primary shaft 451, a secondary shaft 453 is pivotally coupled to the primary shaft 451 by a pivot device 458, such as via a pin and hole configuration. The secondary shaft 453 can comprise a first applicator attachment portion 454 and a second applicator attachment portion 456 that each can receive an applicator, such as applicator 114a having the female receiving portion 116 that can slidably interfaces over the first applicator attachment portion 454, for instance (and another of such applicators can be coupled to the second applicator attachment portion 456). Thus, the secondary shaft 453 can pivot/rotate about pivot device 458, while the primary shaft 451 can rotate about a longitudinal axis of a coupled handle member (e.g., 403 of FIG. 7), and also while the applicators rotate about the first and second applicator attachment portions 454 and 456. Thus, providing three different axes of rotation while the applicators apply a material to a surface.

The applicator attachment portion 480 of FIG. 8 includes a primary shaft 482 having a coupling portion 484 for removably coupling the applicator attachment portion 480 to the elongate member 402 of FIG. 7. The coupling portion 482 can also comprise a roller or bearing assembly that rotatably couples the applicator attachment portion 480 to a handle member or other handle device. At the other end of the primary shaft 482, an applicator can be rotatably coupled to the end of the shaft 482, such as applicator 114a being rotatably coupled to the shaft 482 via the female receiving portion of 116 of FIG. 4. Thus, the primary shaft 482 can rotate about a handle member via the coupling portion 484, while the applicator (e.g., 114a) can rotate about the primary shaft 482. Having two axes of rotation in this manner helps reduce friction, which improves the speed and application of a material to a surface from the applicator.

FIGS. 10 and 11 show a rotary applicator device 500 according to an example of the present disclosure. The rotary applicator device 500 can comprise a handle member 504 comprising a support end portion 505 having an opening 503. The handle member 504 can include a channel 506 that defines a longitudinal axis X7 that extends centrally through the channel 506 and the opening 503. An elongate member 502 can comprise a shaft 508 that extends through the opening 503 and the channel 506, and the shaft 508 can be operable to rotate about an axis of rotation R7, which is substantially collinear with the longitudinal axis X7. The handle member 504 can be an elongated tube or casing, and that has recessed interface portions 507 for grasping with hands. Thus, the rotary applicator device 500 can be a relatively large device for more industrial applications of a material to a surface, much like a paint roller set up.

The shaft 508 can have a diameter that is slightly smaller than an inner diameter of the channel 506. In this manner, the shaft 508 is rotatably supported by and interfaced with the handle member 504. The handle member 504, and the elongate member 502, can be comprised of any suitable rigid material, such as a metal, wood, plastic, polymer, composite, etc.

In one example, the elongate member 502 can removably couple an applicator attachment portion 510 on one end, and a retention member 512 on the other end. The retention member 512 is formed or situated outside of the channel 506 such that the retention member 512 retains the shaft 508 about the channel 106 of the handle member 104. The retention member 512 can be any outward transition portion from the shaft 508 that is capable of preventing the elongate member 502 from falling out of the handle member 504 in one direction.

A transition shaft 509 is coupled to the applicator attachment portion 510, and the transition shaft 509 can be removably coupled to the shaft 508 via a release mechanism 501, such as by threads, a pin, interlocking device, etc. The applicator attachment portion 510 can comprise a cylindrically shaped housing operable to rotate about the axis of rotation R7. Press fit devices 517, such as bent compliant wires, can be coupled to the applicator attachment portion 510 and can extend upwardly. As shown in FIG. 11, an applicator 514 can comprise a female receiving portion 519 (e.g., a cardboard tube section) that is interfaced with or coupled to an outer surface of the applicator attachment portion 510. The applicator 514 can comprise an absorbent material 516 (e.g., natural fibers, polyester, etc.) configured to absorb a material for application onto a surface with the applicator, such as a paint absorbed by the absorbent material for rolling onto a surface such as a wall or other surface. The absorbent material 516 can be attached to (e.g., glued) an outer surface area of the female receiving portion 519.

Thus, in one example with reference to FIG. 10, assume that a user has removably attached the applicator 514 to the applicator attachment portion 510 in the manner described above. The user then grasps or holds the handle member 504 (e.g., with both hands), dips the applicator 514 into a viscous material (e.g., paint), and then interfaces the applicator 514 against a surface, such as near a corner of a wall to be painted. Then, the user can move the handle member 504 along or proximate the surface, thereby causing rotation of the applicator 514 along the surface and about an axis of rotation R7 to deposit a portion of the material from the applicator 514 onto the surface. Notably, the axis of rotation R7 of the applicator 514 is substantially collinear with the longitudinal axis X7 of the handle member 504, because of the rotatable interface configuration of the applicator 514 and the elongate member 502, as detailed above. Thus, while the handle member 504 is moved in a direction (i.e., by the user along or about the surface) transverse to the longitudinal axis X7, the elongate member 502 and the applicator 514 are collectively operable to rotate about the axis of rotation R7 and about the longitudinal axis X7.

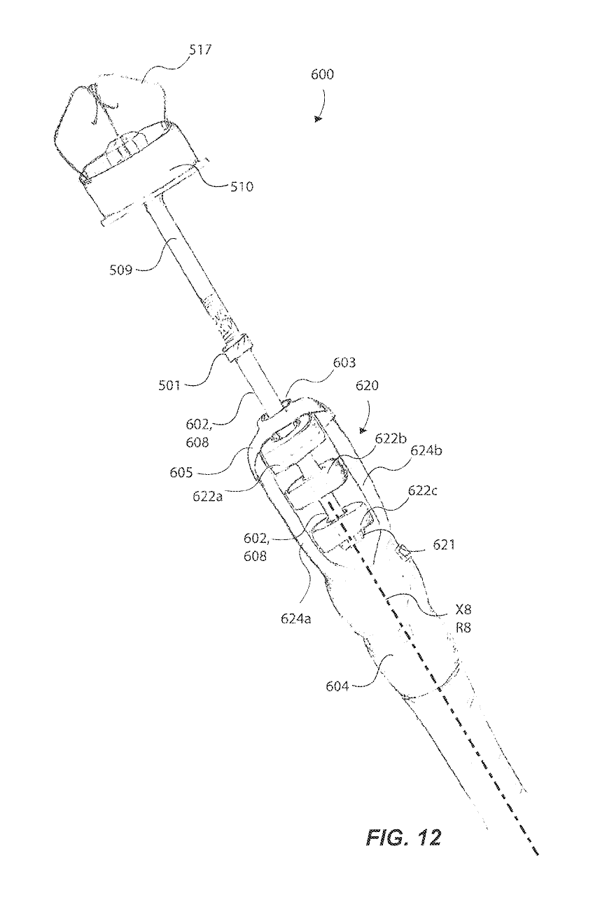

FIG. 12 shows a rotary applicator device 600 according to an example of the present disclosure. The rotary applicator device 600 can comprise a handle member 604 comprising a support end portion 605 having an opening 603. The handle member 604 and the opening 603 define a longitudinal axis X8 that extends centrally through the opening 603. The rotary applicator device 600 can include the applicator attachment portion 510 and the transition shaft 509 of FIG. 10, so they will not be discussed in great detail in this example, but their reference numbers will be reproduced in FIG. 12 for reference.

The rotary applicator device 600 can comprise an applicator bearing assembly 620 that rotatably couples the applicator attachment portion 510 to the handle housing 604, so that the applicator (e.g., 514) can rotate along a surface to apply a material while the handle housing 604 is moved and operated. More specifically, the bearing assembly 620 can comprise an elongate member 602 comprising a shaft 608 rotatably interfaced to the opening 603 of the support end portion 605, and where the shaft 608 is situated along the longitudinal axis X8. The bearing assembly 620 can comprise at least one bearing 622a-c coupled to the shaft 608 and rotatably interfacing the elongate member 602 to the support end portion 605 of the handle member 604.

Each bearing 622a-c can be a cylindrical ball bearing device having central apertures that are rotatably interfaced or coupled to a portion of the shaft 608. A lower nut or fastener 621 can be attached to an end of the shaft 608 to retain the bearings 622a-c in place. Spacers can be provided between adjacent bearings 622a-c, such as shown as the spacers 615a and 615b shown in the exploded view of FIG. 13 of the bearing assembly. The handle member 604, proximate the support end portion 605, can comprise a first bearing support portion 624a and a second bearing support portion 624a extending in a direction parallel to the longitudinal axis X8, and disposed on respective sides of the bearings 622a-c. Thus, outer surfaces of the bearings 622a-c can be slidably interfaced with inside surfaces of the first and second bearing support portions 624a and 624b. The first and second bearing support portions 624a and 624b provide a certain amount of structural support and rigidity to the shaft 608 and the applicator attachment portion 610, via the bearings 622a-c, while applying a material to a surface.

Accordingly, assume that a user has removably attached the applicator 514 to the applicator attachment portion 510 in the manner described above (FIG. 10). The user then grasps or holds the handle member 604, dips the applicator 514 into a viscous material (e.g., paint), and then interfaces the applicator 514 against a surface, such as near a corner of a wall to be painted. Then, the user can move the handle member 604 along or proximate the surface, thereby causing rotation of the applicator 514 along the surface and about an axis of rotation R8 to deposit a portion of the material from the applicator 514 onto the surface. The transition shaft 509, the shaft 608, and the bearings 622a-c can all rotate about a common axis being the axis of rotation R8. Notably, the axis of rotation R8 is substantially collinear with the longitudinal axis X8 of the handle member 604. Thus, while the handle member 604 is moved in a direction (i.e., by the user along or about the surface) transverse to the longitudinal axis X8, the elongate member 602 and the applicator 614 are collectively rotate about the axis of rotation R8 and about the longitudinal axis X8.

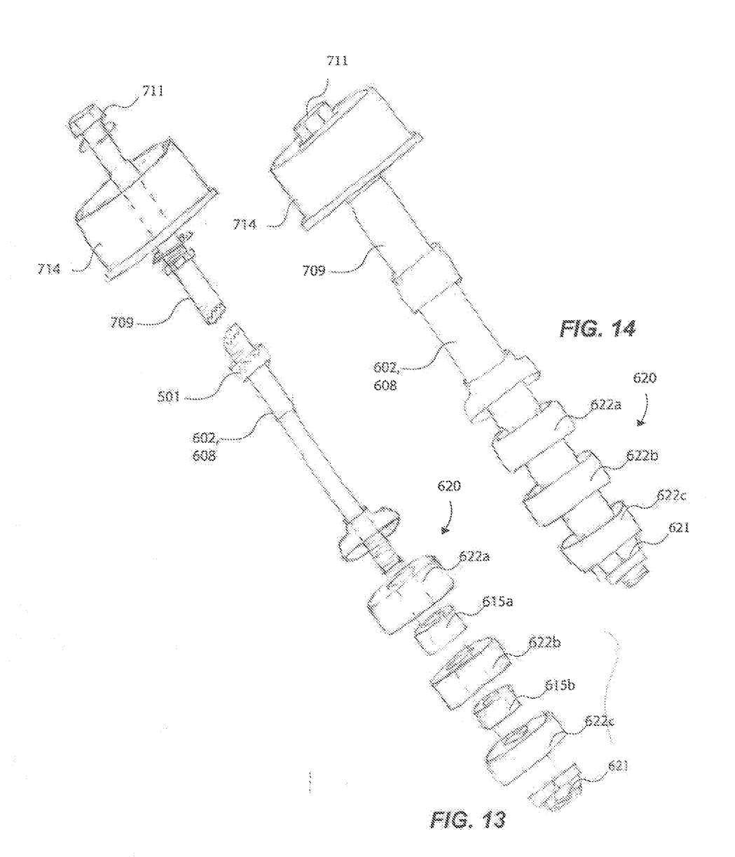

FIGS. 13 and 14 show an applicator attachment portion 710 that can be removably coupled to the bearing assembly 620 of FIG. 12, and that can be incorporated with the handle member 604 and support end portion 605 of FIG. 12. Here, the applicator attachment portion 710 comprises a transition shaft 709 that removably couples an applicator 714 via a nut 711. The applicator 714 can be a disk or puck of absorbing material, and having a central aperture through which an end portion of the transition shaft 709 extends through. Thus, as shown in FIG. 14, the end portion of the transition shaft 709 can include a threaded portion that threadably engages with the nut 711 to hold in place the applicator 714. The applicator 714 can absorb a material, such as a paint, and then be rolled along a surface to apply the material, in a similar manner as described regarding FIG. 12.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The user of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A rotary applicator device, comprising:
a handle member having a longitudinal axis;
an elongate member rotatably interfaced with the handle member, the elongate member comprising an applicator attachment portion; and
an applicator removably coupled to the applicator attachment portion and comprised of an absorbent material configured to absorb a material,
wherein the elongate member and the applicator are operable to rotate about the longitudinal axis while the handle member is moved in a direction transverse to the longitudinal axis, thereby facilitating deposit of a portion of the material from the applicator onto a surface while the applicator rotates along the surface.

2. The rotary applicator device of claim 1, wherein the handle member comprises a channel that extends through the handle member and along the longitudinal axis, and wherein the elongate member comprises a shaft that extends through the channel and rotatably supported by the handle member.

3. The rotary applicator device of claim 2, wherein the elongate member comprises a retention member on an end opposite the applicator attachment portion, the retention member situated outside of the channel such that the retention member retains the shaft about the channel of the handle member.

4. The rotary applicator device of claim 1, wherein the applicator comprises a dauber configured to absorb and apply an stain material.

5. The rotary applicator device of claim 1, wherein the applicator attachment portion is configured to attach different types of applicators.

6. The rotary applicator device of claim 1, wherein the applicator attachment portion is pivotally coupled to a distal end of the shaft, such that the applicator is operable to rotate along an axis of rotation at varying angles relative to the longitudinal axis of the handle member.

7. The rotary applicator device of claim 1, wherein the handle member comprises a support end portion having an opening, the longitudinal axis extending through the opening, wherein the shaft is rotatably interfaced to the opening and situated along the longitudinal axis, the rotary applicator device further comprising at least one bearing coupled to the shaft and rotatably interfacing the elongate member to the support end portion.

8. The rotary applicator device of claim 7, wherein the at least one bearing comprises a plurality of cylindrical ball bearing devices, the shaft coupled to central apertures of each cylindrical ball bearing device.

9. The rotary applicator device of claim 7, wherein the handle member comprises a first handle portion and a second handle portion pivotally coupled to each other by a pivoting lock mechanism, the second handle portion supporting the applicator attachment portion such that the applicator attachment portion and the applicator rotate off-axis relative to the longitudinal axis extending through the first handle portion.

10. The rotary applicator device of claim 1, wherein the applicator comprises an axis of rotation being substantially collinear with the longitudinal axis of the handle member.

11. A rotary applicator device, comprising:
a handle member comprising a channel that extends through the handle member, the handle member defining a longitudinal axis;
an elongate member comprising an shaft that extends through the channel, the shaft being rotatably supported by the handle member, the elongate member comprising an applicator attachment portion; and
an applicator removably coupled to the applicator attachment portion and comprised of an absorbent material configured to absorb a material for application onto a surface with the applicator,
wherein the elongate member and the applicator are operable to rotate about the longitudinal axis while the handle member is moved in a direction transverse to the longitudinal axis, thereby facilitating deposit of a portion of the material from the applicator onto the surface while the applicator rotates along the surface.

12. The rotary applicator device of claim 11, wherein the elongate member comprises a retention member on an end opposite the applicator attachment portion, the retention member situated outside of the channel such that the retention member retains the shaft about the channel of the handle member.

13. The rotary applicator device of claim 11, wherein the applicator comprises an axis of rotation being substantially collinear with the longitudinal axis of the handle member.

14. The rotary applicator device of claim 11, wherein the shaft comprises an axis of rotation being substantially collinear with the longitudinal axis of the handle member.

15. The rotary applicator device of claim 11, wherein the applicator attachment portion is pivotally coupled to a distal end of the shaft, such that the applicator is operable to rotate along an axis of rotation at varying angles relative to the longitudinal axis of the handle member.

16. A rotary applicator device, comprising:
a handle member comprising a support end portion having an opening, the handle member defining a longitudinal axis extending through the opening;
an applicator bearing assembly comprising:
an elongate member comprising a shaft rotatably interfaced to the opening of the support end portion, the shaft being situated along the longitudinal axis;
at least one bearing coupled to the shaft and rotatably interfacing the elongate member to the support end portion of the handle member;
an applicator attachment portion coupled to a distal end of the shaft; and
an applicator removably coupled to the applicator attachment portion, and comprised of an absorbent material configured to absorb a material for application onto a surface with the applicator,
wherein the elongate member and the applicator are operable to rotate about the longitudinal axis while the handle member is moved in a direction transverse to the longitudinal axis, thereby facilitating deposit of a portion of the material from the applicator onto the surface while the applicator rotates along the surface.

17. The rotary applicator device of claim 16, wherein the at least one bearing comprises a plurality of cylindrical ball bearing devices, the shaft coupled to central apertures of each cylindrical ball bearing device.

18. The rotary applicator device of claim 16, wherein the handle member comprises a first handle portion and a second handle portion pivotally coupled to each other by a pivot lock mechanism, the second handle portion supporting the applicator attachment portion such that the applicator attachment portion and the applicator rotate off-axis relative to the longitudinal axis extending through the first handle portion.

19. The rotary applicator device of claim 16, further comprising a release mechanism supported by an end of the shaft, the release mechanism operable to facilitate removal of the applicator attachment portion from the shaft.

20. The rotary applicator device of claim 19, wherein the release mechanism facilitates interchanging different types of applicators to the shaft.
